(19) United States
(12) Patent Application Publication
(10) Pub. No.: US 2019/0032769 A1
(43) Pub. Date: Jan. 31, 2019

(54) TRANSFER STRUCTURE FOR VEHICLE

(71) Applicant: Mazda Motor Corporation, Hiroshima (JP)

(72) Inventors: Yuzo Ohkawa, Hiroshima-shi (JP); Yoshihito Noguchi, Hiroshima-shi (JP); Wataru Harazawa, Hiroshima-shi (JP)

(21) Appl. No.: 15/991,052

(22) Filed: May 29, 2018

(30) Foreign Application Priority Data
Jul. 25, 2017 (JP) 2017-143525

(51) Int. Cl. F16H 57/04; B60K 17/346

(52) U.S. Cl. CPC F16H 57/0423; F16H 2057/02043; B60K 17/3467; F16H 57/0483

(57) ABSTRACT

A transfer device includes a drive gear, a driven gear arranged at a lower position than the drive gear, and a housing space storing gears, wherein a lubricating oil is reserved in a lower part of the housing space, wherein first and second lubricating oil reservoir spaces reserving the lubricating oil respectively adjacent to the housing space are partitioned from the housing space by first and second partition walls, wherein communication holes communicating in a state of restricting the flow to the housing space are respectively provided on the first and the second partition walls, wherein the first partition wall is provided at a lower position than a predetermined oil level and the second partition wall is provided at a higher position than the predetermined oil level.

### FIELD OF THE INVENTION

The present invention relates to a transfer structure mounted on a four-wheel drive vehicle.

### BACKGROUND ART

A type of four-wheel drive vehicle is well known, which is configured with a driving source such as an engine and a transmission in a front of the vehicle body so as to extend along a central axis in a longitudinal direction of the vehicle body, which is provided with a transfer device that, along with transmitting the driving force output from the transmission to the rear wheels as main driving wheels via a rear wheel output shaft extending toward a rear of the vehicle body and a differential gear for the rear wheels, draws the driving force to be output to the front wheels as auxiliary driving wheels, which transmits the driving force drawn by the transfer device to the front wheels via an output shaft for the front wheels extending toward the front of the vehicle and a differential gear for front wheels, and which transmits the driving force drawn by the transfer device to the front wheels via an output shaft for the front wheels extending toward the front of the vehicle body and a differential gear for front wheels, to thereby make the front wheels drivable in addition to the rear wheels.

Conventionally, such a transfer device is configured to provide a coupling to draw the driving force for the front wheels from the rear wheel output shaft, and to transmit the driving force drawn by the coupling to the front wheel output shaft via a drive sprocket, which is a rotation member provided on the rear wheel output shaft, a driven sprocket, which is a rotation member provided on the front wheel output shaft that is provided in parallel on the rear wheel output shaft, and a chain-type power transmission mechanism consisting of chains wound around both sprockets, to thereby make the front wheels drivable in addition to the rear wheels.

Moreover, the power transmission mechanism has a gear type power transmission mechanism that is configured by a drive gear as a gear of one side provided on the rear wheel output shaft and a driven gear as a gear of the other side provided on the front wheel output shaft.

Then, the lubrication of the power transmission mechanism of the transfer device performs a lapping up resupply action by lapping up the lubricating oil, which is reserved in a lower part of a housing space storing the power transmission mechanism, from a power transmission member positioned at a lower place to a power transmission member positioned at a higher place, the drive side power transmission member being selected from among a gear or a sprocket and the like included within the power transmission mechanism or the driven side power transmission member.

However, in this lapping up resupply action, especially when the vehicle travels at high speed, since the rotation of the power transmission member of the lapping up side rotates quickly, depending on the oil level of the lubricating oil reserved in an oil storage part, the stirring resistance caused by lapping up of the oil by the power transmission member increases, and this may cause deterioration in fuel economy.

On the other hand, the power transmission mechanism of the transfer device disclosed in Patent Document 1 is configured to form a housing space storing a sprocket and a chain driven by the sprocket which collectively form a power transmission mechanism, and a partition wall is provided along a lower part of the chain and provides an oil storage part for storing lubricating oil that lubricates the power transmission mechanism on a lowest part of the housing space. A communication hole communicating the housing space with the oil storage part is provided on a bottom part of the partition wall and the lubricating oil reserved in the oil storage part is supplied from the communication hole to the housing space.

Accordingly, since the lubricating oil is supplied from the communication hole to the housing space, when the vehicle travels at high speed, the lapped-up amount of the lubricating oil of the housing space is large, so that the oil level can be reduced. As the result of that, the stirring resistance by lapping up the lubricating oil can be suppressed.

### RELATED ART

### Patent Document

[PATENT DOCUMENT 1] Japanese Unexamined Utility Model Application Publication No. SHO 61-20959.

### SUMMARY OF THE INVENTION

### Problems to be Solved by the Invention

However, with an oil level setting that is appropriate in high speed traveling conditions as described above, since the rotation of the power transmission mechanism decreases in speed during the low speed traveling (which is a slow speed compared with in high speed traveling), the amount of lapping up of the lubricating oil by the lower positioned power transmission member (the power transmission member of the lapping up side) is decreased, so that a problem might occur, namely, the lubrication by the predetermined lubrication oil of the higher positioned power transmission member may become insufficient.

In particular, in the case that the drive gear and the driven gear of the gear type power transmission mechanism are formed by the helical gears, which are excellent in strength and silent operation, when lapping up resupplied oil, the lubricating oil that is lapped up from the housing space by the lower side gear (lapping up side gear) positioned at a lower position between the drive gear and the driven gear is easily scattered to one side of the axial direction of the lower side gear according to the inclination of the tooth surface of the lower side gear, so that the lubrication of the other side might be insufficient.

In order to solve such a lubrication shortage by decreasing the amount of lapping up of the lubricating oil at low speed traveling or the lubrication shortage by the deviation of the lubricating oil supply in the lubrication of the power transmission mechanism, a method of increasing the lapping up amount of the lubricating oil by increasing the oil level in the housing space may be considered; however, as described above, such an approach causes the stirring resistance of the power transmission member on the lapping up side to be increased.

Therefore, the purpose of the present invention is to reduce the oil level of the housing space of the transfer device during high speed traveling and address the problem of lubrication shortage during low speed traveling, and address the problem of lubrication shortage caused by the imbalance of the oil supply amount caused by helical gears.

### BRIEF SUMMARY OF THE INVENTION

In order to solve the above discussed problems, a transfer structure of a vehicle according to the present invention may be configured as follows.

According to a first configuration, a transfer structure includes a first rotation member arranged at a high position corresponding to a higher one of a drive side power transmission member and a driven side power transmission member, a power transmission mechanism having a second rotation member arranged at a lower position than the first rotation member, a case for supporting the first rotation member and the second rotation member, and a housing space storing the power transmission mechanism in the case. A lubricating oil is reserved in a lower part of the housing space so as to submerge a lower part of the second rotation member, the lubricating oil is lapped up by the second rotation member and supplied to the first rotation member, and a first lubricating oil reservoir space and a second lubricating oil reservoir space for reserving the lubricating oil respectively adjacent to the housing space are provided in the case. A first partition wall partitions between the housing space and the first lubricating oil reservoir space, a second partition wall partitions between the housing space and the second lubricating oil reservoir space, a first communication oil passage for communicating in a state of restricting the flow of the lubricating oil between the housing space and the first lubricating oil reservoir space is provided on the first partition wall, a second communication oil passage for communicating in a state of restricting the flow of the lubricating oil between the housing space and the second lubricating oil reservoir space is provided on the second partition wall, and the first partition wall is provided at a lower position than a predetermined oil level set as an oil level when the vehicle stops, and the second partition wall is provided at a higher position than the predetermined oil level.

In a second configuration based on the first configuration, the first lubricating oil reservoir space may be provided at a position overlapped with the housing space as viewed along a direction orthogonal to an axial direction of the first rotation member.

Further, in a third configuration based on the first configuration, the second lubricating oil reservoir space may be provided at a position overlapped with the housing space as viewed along an axial direction of the first rotation member.

Furthermore, a fourth configuration based on the first configuration, the first and second communication oil passages of the first partition wall and the second partition wall may be configured by respective communication holes.

Moreover, in a fifth configuration based on the first configuration, the first rotation member and the second rotation member may be helical gears, a first lubricating oil reservoir space may be provided on the front side in a rotating direction of the second rotation member, the first partition wall may be provided along a tooth surface of the second rotation member, and the first communication oil passage of the first lubricating oil reservoir space may be provided on the front side in the rotating direction of the tooth surface of the second rotation member on the first partition wall.

### Effects of the Invention

In the first configuration described above, the first lubricating oil reservoir space and the second lubricating oil reservoir space are formed by the first partition wall that is lower than a predetermined oil level set in the housing space and the second partition wall that is higher than the predetermined oil level, and a communicating condition is formed by each communication oil passage, which restricts the flow of the lubricating oil to the housing space. For example, in the case of setting the predetermined oil level to an oil level when the vehicle stops (the oil level when the second rotation member stops), when the second rotation member stops, the lubricating oil of the first lubricating oil reservoir space, the second lubricating oil reservoir space, and the housing space become the same oil level as a communication oil passage provided on the first and the second partition walls due to the flow of lubricating oil at a higher position than the first partition wall.

Moreover, at the low speed rotation of the second rotation member, since the amount of the lubricating oil that is lapped up by the second rotation member is small, the oil level of the housing space is reduced to be low. Further, since the lubricating oil reserved in the first and the second lubricating oil reservoir spaces flows into the housing space via the communication oil passages provided on the first and the second partition walls while the oil level of the housing space is lowered, a change of the oil level of the lubricating oil reserved in the first and the second lubricating oil reservoir drops by a small amount. Therefore, since the oil level in the first lubricating oil reservoir space is higher than that of the first partition wall, the lubricating oil is supplied to the housing space by flowing over the first partition wall in addition to passing through the communication oil passage. As a result, the oil level in the housing space can be maintained at a level sufficient to avoid a shortage of lubrication at low speed rotation.

On the other hand, at high speed rotation of the second rotation member, since the amount of the lubricating oil that is lapped up by the second rotation member is large, the oil level of the housing space drops by a large amount. Then, since the lubricating oil reserved in the first and second lubricating oil reservoir spaces flows into the housing space via the communication oil passages provided in the first and second partition walls, the oil level of the lubricating oil reserved in the first and second lubricating oil reservoir spaces is raised. Moreover, when the oil level in the first lubricating oil reservoir space reaches the height of the first partition wall, since the lubricating oil cannot be reserved any further, the lubricating oil that was lapped up by the second rotation member is collected in the second lubricating oil reservoir space.

As a result, since the lubricating oil is supplied to the housing space by the communication oil passages that restrict flow through the first and second partition walls, the oil level in the housing space can be lowered and the stirring resistance of the second rotation member at high speed rotation can be reduced.

Moreover, when shifting from high speed rotation to low speed rotation of the second rotation member, since the amount of lubricating oil that is lapped up by the second rotation member becomes small, the oil level of the housing space is increased by supplying the lubricating oil from the communication oil passage. Then, when the oil levels of the housing space and the first lubricating oil reservoir space reach the height of the first partition wall, the lubricating oil that is reserved in the first lubricating oil reservoir space flows into the housing space by flowing over the first partition wall. According to this, since the lubricating oil is supplied from three directions, namely the two communication oil passages and over the partition wall, the oil level in the housing space can be kept at the amount of the lubricating oil that is required at the time of low speed rotation.

By configuring as described above, the oil levels respectively suitable for low speed rotation time and high speed rotation time can be obtained, and improvements that address both the lubrication shortage at the time of low speed rotation and the reduction of the stirring resistance at the time of high speed rotation can be achieved.

Moreover, the invention according to the second configuration further specifies the arrangement of the first lubricating oil reservoir space described in the first configuration, and since the first lubricating oil reservoir space is provided at a position overlapped with the housing space as viewed along a direction orthogonal to an axial direction of the first rotation member, a dimension of the vehicle body in the longitudinal direction of the transfer device can be shortened.

Further, the invention according to the third configuration further specifies the arrangement of the second lubricating oil reservoir space described in the first or second configurations, since the second space is provided at a position overlapped with the housing space as viewed along an axial direction of the first rotation member, a dimension of the vehicle width direction of the transfer device can be reduced. Thus, by applying the third configuration to the second configuration, the first lubricating oil reservoir space and the second lubricating oil reservoir space are distributed in a manner that effectively utilizes space.

Moreover, the invention according to the fourth configuration further specifies the communication oil passages described in the first configuration, and since the communication oil passages in the first partition wall and the second partition wall are configured as a communication hole, a communicating state that restricts the flow can be realized with a simple configuration.

Further, according to the invention described in the fifth configuration, the second gear is formed by a helical gear, and since the communication hole of the first partition wall partitioned between the first space and the housing space is provided on the front side in a rotation direction of the tooth surface of the second gear, the lubricating oil that is supplied from the first space via the communication hole is easily taken into the housing space by the pumping action of the second gear. As a result, the communication hole can be set to be small for securing the required flow rate of the lubricating oil, and consequently, for example, the deterioration of the strength and rigidity of the partition wall can be suppressed when providing the communication oil passage in the partition wall.

### BRIEF DESCRIPTION OF THE DRAWINGS

FIG. 1 is a schematic illustration showing a power transmission mechanism of a four-wheel drive vehicle, on which a transfer device is mounted, according to an embodiment of the present invention.

FIG. 2 is a cross-sectional enlarged view showing the transfer device.

FIG. 3 is a sectional view of the transfer device at a position shown by arrows A-A in FIG. 4.

FIG. 4 is a front elevation view taken at arrows D-D in FIG. 2 when a cover of a transfer case of the transfer device is removed.

FIG. 5 is a perspective view when the case of the transfer device is removed according to an embodiment of the present invention.

FIGS. 6A to 6C are explanatory drawings illustrating the operation of the housing space and the lubricating oil reservoir space of the transfer device.

### DETAILED DESCRIPTION OF THE EMBODIMENTS

Hereinafter, details of a transfer device of a vehicle according to an embodiment of the present invention will be described.

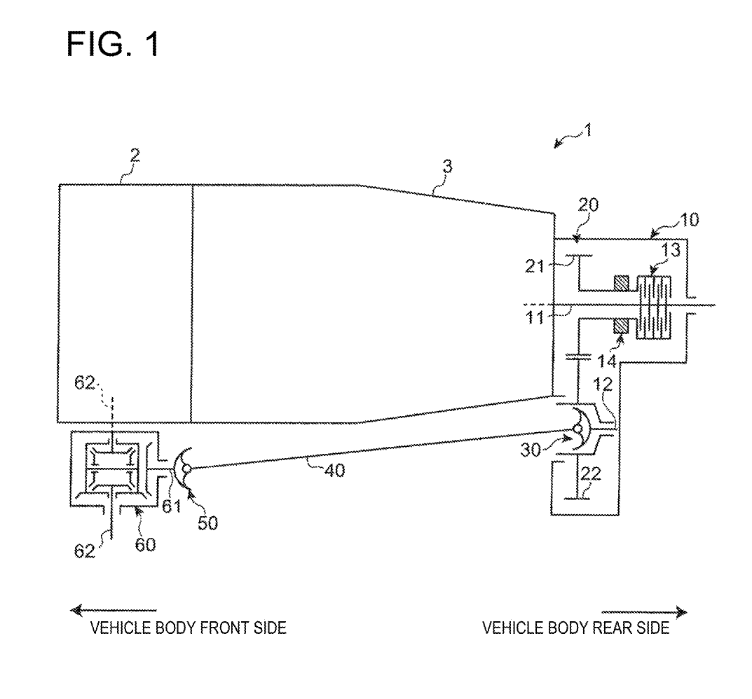

FIG. 1 shows a four-wheel drive vehicle 1 equipped with a transfer device according to an embodiment of the present invention. Vehicle 1 is a four-wheel drive vehicle based on a front engine/rear drive layout, and an engine 2 and a transmission 3 as a driving source are provided in a front of the vehicle so as to extend along a central axis in a longitudinal direction of the vehicle body.

A transfer device 10 is provided on a rear side of the transmission 3, and an output shaft for the rear wheels 11, which extends to the vehicle rear side and outputs the driving force output from the transmission to the rear wheels, and a front wheel output shaft 12, which is arranged in parallel to the rear wheel output shaft 11 and outputs the driving force to the front wheels, are provided in the transfer device 10.

A coupling 13, a drive gear 21 as a first gear, which is arranged on a front side relative to the vehicle body of the coupling 13 and also transmits the driving force drawn from the coupling 13 to the front wheel output shaft 12, and a damper device 14, which is arranged between the coupling 13 and the drive gear 21, are provided on the rear wheel output shaft 11.

Moreover, a driven gear 22 as a second gear, which is engaged with the drive gear 21 is provided on the front wheel output shaft 12, and the driving force for front wheels drawn by the coupling 13 is transmitted to the front wheel output shaft 12 via the drive gear 21 and the driven gear 22.

Further, the drive gear 21 and the driven gear 22 are helical gears, and collectively form a power transmission mechanism 20.

The front wheel output shaft 12 is connected to a front wheel propeller shaft 40 extending to the front side of the vehicle body via a universal joint 30. The front wheel propeller shaft 40 is connected to an input shaft 61 of a front wheel differential gear 60 via the universal joint 50 and the input shaft 61 is connected to the axles 62, 62 that are respectively connected to the right and left front wheels.

Accordingly, the driving force drawn by the coupling 13 is transmitted to the front wheel output shaft 12 via the drive gear 21 and the driven gear 22 and transmitted from the front wheel output shaft 12 to the front wheels via the front wheel propeller shaft 40 and the differential gear for front wheels 60. For the four-wheel drive vehicle 1, the coupling 13 can change the torque distribution between the front wheels and the rear wheels within a range of front wheels:rear wheels of 0:100 to 50:50. Moreover, the operations of the coupling 13 are controlled by a control unit (not shown) that includes a processor and associated non-volatile memory storing control programs that are executed by the processor to achieve the functions described herein.

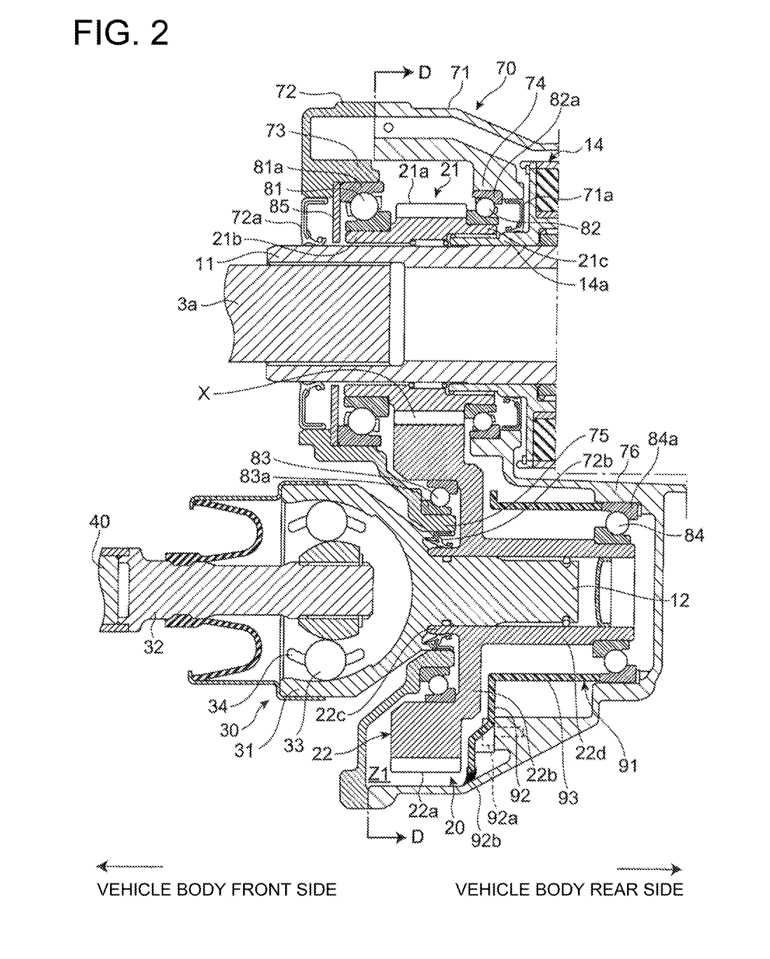

Next, with reference to FIG. 2, further details of the transfer device 10 according to the embodiment of the present invention will be described.

A case 70 of the transfer device 10, as shown in FIG. 2, is formed by fastening a main body 71 and a cover 72 covering the transmission 3 side of the main body 71 with a bolt (not shown).

The rear wheel output shaft 11, which is connected to an input shaft 3a from the transmission 3, and the front wheel output shaft 12, which is provided in parallel to the rear wheel output shaft 11, are rotatably supported in the transfer case 70. A housing space Z1, which stores the drive gear 21 forming the power transmission mechanism 20 and the driven gear 22, is formed between the main body 71 and the cover 72 of the transfer case 70.

Moreover, the driven gear 22 of the power transmission mechanism 20 is provided on the rear wheel output shaft 11 in a hollow shaft form, the driven gear 22 is provided on the front wheel output shaft 12 in a hollow shaft form, and the drive gear 21 and the driven gear 22 are arranged to be engaged with each other.

Teeth 21a are formed with slanted teeth profiles on the outer peripheral surface of the drive gear 21, and a cylindrically shaped front side cylindrical part 21b and a cylindrically shaped rear side cylindrical part 21c, which integrally extend from the inner peripheral side of the teeth 21a to the vehicle body front side and the vehicle body rear side respectively, are arranged on the drive gear 21. The drive gear 21 is rotatably supported in the transfer case 70 via bearings 81 and 82 provided on the outer peripheral side of the front side cylindrical part 21b and the rear side cylindrical part 21c.

An outer race 81a of the bearing 81 of the vehicle body front side, among the bearings 81 and 82, is press fitted into a press-fit part 73 consisting of a circular concavity provided on the cover 72 of the transfer case 70. On the other hand, an outer race 82a of the bearing 82 of the vehicle body rear side is press fitted into a press-fit part 74 consisting of a circular concavity provided on the main body 71 of the transfer case 70.

Moreover, a plate member 85, which is in contact with the outer race 81a of the bearing 81 and also extends from the inner peripheral surface of the press-fit part 73 of the cover 72 to the outer peripheral surface of the rear wheel output shaft 11 of the transfer device 10, is provided on an end part of the vehicle body front side of the bearing 81, and the axial direction of the bearing 81 is positionally fixed in this manner.

Teeth 22a are formed with slanted teeth profiles on the outer peripheral surface, and a longitudinal surface part 22b extending to inner peripheral side of the teeth 22a and extending from the end part of the vehicle body rear side to the inner peripheral side, and a cylindrically shaped front side cylindrical part 22c and a cylindrically shaped rear side cylindrical part 22d extending from the end part of the inner peripheral side of the longitudinal surface part 22b to the vehicle body front side and the vehicle body rear side respectively, are arranged on the driven gear 22. The driven gear 22 is rotatably supported in the transfer case 70 via bearings 83 and 84 provided on the inner peripheral side of teeth 22a and the outer peripheral side of the rear side cylindrical part 22d.

The bearing 83 of the vehicle body front side, among the bearings 83 and 84 of the driven gear 22, is arranged below an engaging part X between the drive gear 21 and the driven gear 22 viewing the radial direction of the driven gear 22, and also an inner race 83a of the bearings 83 of the vehicle body front side is press fitted into a press-fit part 75 consisting of a circular concavity provided on the cover 72 of the transfer case 70. On the other hand, an outer race 84a of the bearing 84 of the vehicle body rear side is press fitted into the press-fit part 76 consisting of a circular concavity provided on the main body 71 of the transfer case 70.

Moreover, lubricating oil for lubricating the power transmission mechanism 20 is reserved in a lower part of the housing space Z1 so as to submerge a lower part of the driven gear 22, the lower part of the housing space Z1 thus functioning as an oil storage part.

The front wheel output shaft 12 is spline-fitted and connected to the inner peripheral surface of the front side and the rear side cylindrical parts 22c and 22d of the driven gear 22. The front wheel output shaft 12 is connected to a front wheel propeller shaft 40 via the universal joint 30 and an outside joint member 31 of the universal joint 30 is integrally formed with the vehicle body front side of the front wheel output shaft 12.

The universal joint 30 includes the outside joint member 31 that is integrally formed to the front wheel output shaft 12, an inside joint member 32 that is coupled to the front wheel propeller shaft 40, one or more balls 33 that are interposed between the outside joint member 31 and the inside joint member 32 and transmit power between the outside joint member 31 and the inside joint member 32, and a cage 34 that is arranged between the inner peripheral surface of the outside joint member 31 and the outer peripheral surface of the inside joint member 32 and retains the balls 33, and can transmit power between the front wheel output shaft 12 and the front wheel propeller shaft 40.

Moreover, for the transfer device 10, a plurality of seal members 71a, 72a, and 72b are arranged in the transfer case 70, and the lubricating oil in the transfer case 70 is prevented from leaking outside. Specifically, the seal member 72a is arranged between the cover 72 of the transfer case 70 and the rear wheel output shaft 11, the seal member 72b is arranged between the cover 72 of the transfer case 70 and the front side cylindrical part 22c of the driven gear 22, and the seal member 71a is arranged between the main body 71 of the transfer case 70 and the power transmission member 14a extending from the damper device 14 provided on the rear wheel output shaft 11.

Moreover, the lubricating oil to lubricate the power transmission mechanism 20 and the bearings 81, 82, 83, and 84 and the like is reserved in the transfer device 10.

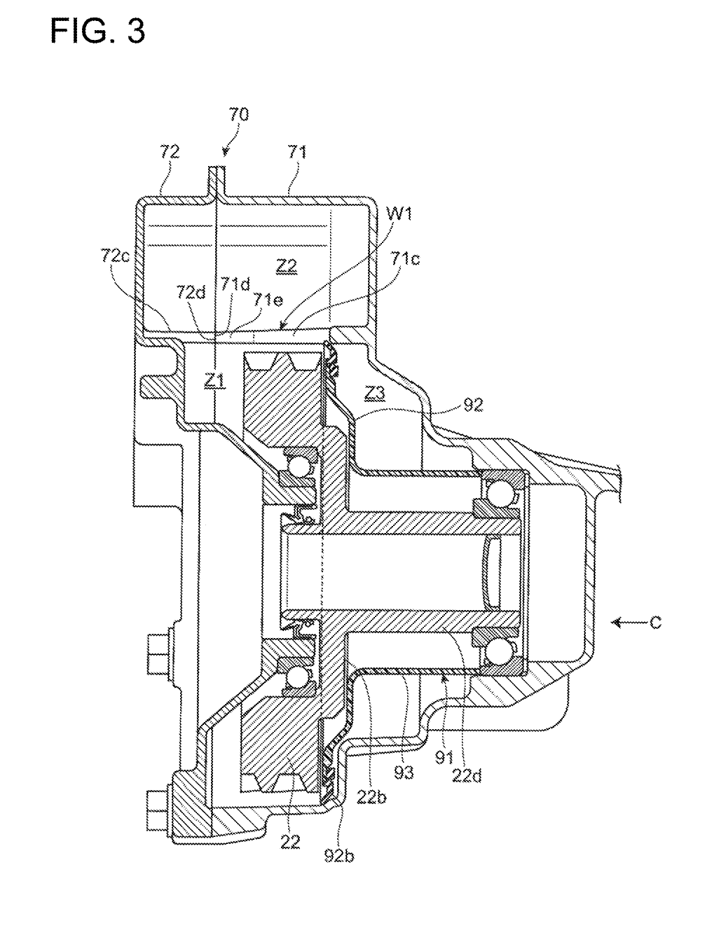

Hereinafter, details about a lubricating oil reservoir space, in which the lubricating oil is reserved, will be described with reference to FIG. 3 to FIG. 5.

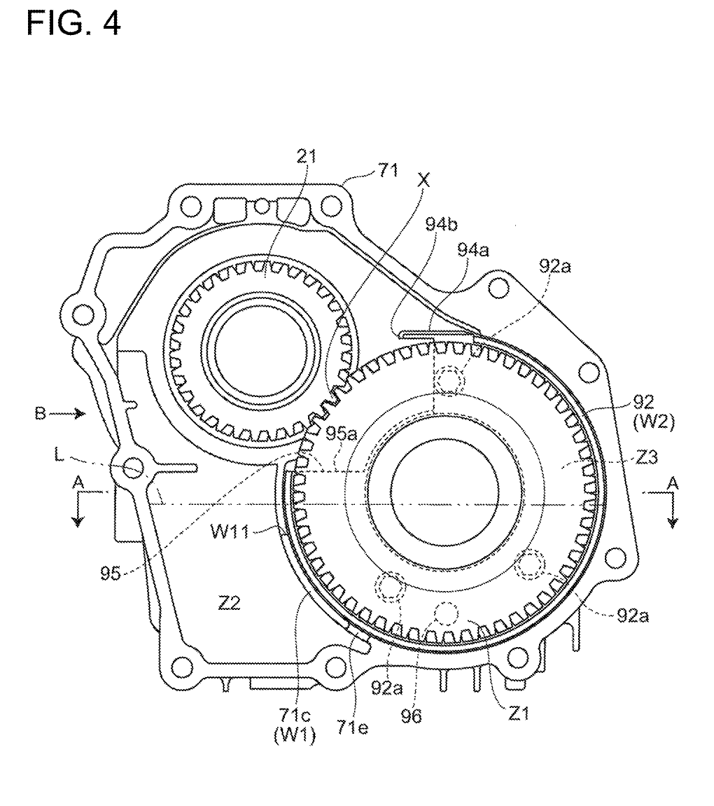

FIG. 3 shows the A-A cross section in FIG. 4, the lubricating oil as shown in the figure is reserved in a first lubricating oil reservoir space Z2 provided at the position overlapped with a housing space Z1 viewing the orthogonal direction to the front wheel output shaft 12 (arrow B in FIG. 4) and a second lubricating oil reservoir space Z3 provided at the position overlapped with the driven gear 22 viewing the axial direction of the front wheel output shaft 12 (arrow C in FIG. 3) in addition to the housing space Z1 of the transfer case 70.

The first lubricating oil reservoir space Z2 is formed by partitioning between the lower part of the transfer case 70 and the housing space Z1 by the first partition wall W1.

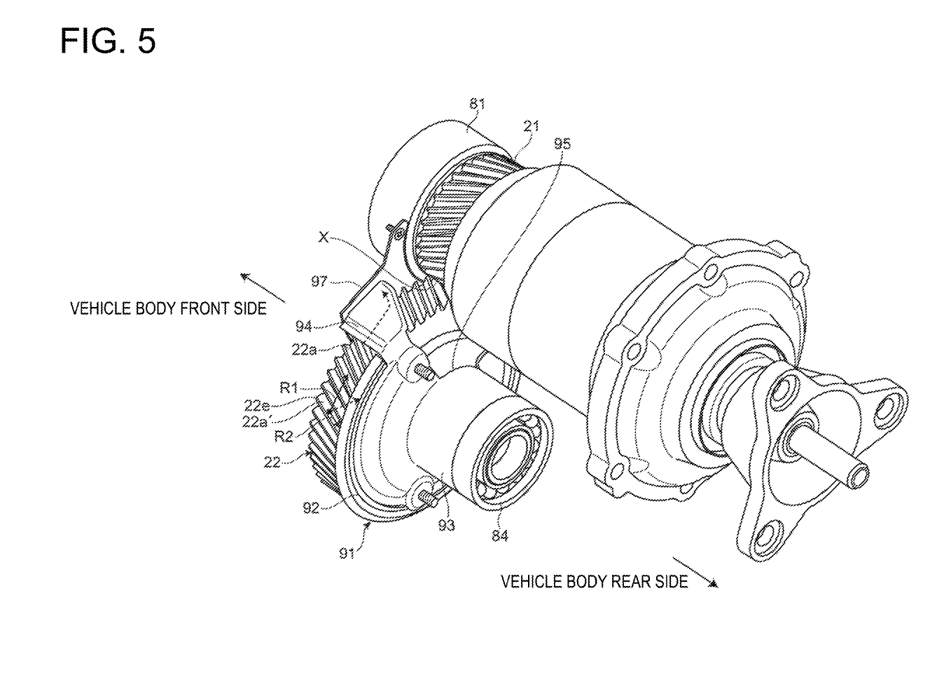

Specifically, as shown in FIG. 3 and FIG. 4, a partition wall 71c, which is adjacent to the teeth 22a of the driven gear 22 at a lower part of the main body 71 of the transfer case 70 and also extends across a tooth width direction of the driven gear 22, is provided on the lower part of the transfer case 70. Moreover, as shown in FIG. 3 and FIG. 5, on the lower part of the cover 72 of the transfer case 70, a partition wall 72c is provided at a position corresponding to the partition wall 71c of the main body 71.

Further, as shown in FIG. 3, when connecting the main body 71 and the cover 72, the first partition wall W1 (71c and 72c) partitioning between the housing space Z1 and the first lubricating oil reservoir space Z2 is formed by contacting an end face 71d of the vehicle body front side of the partition wall 71c with an end face 72d of the vehicle body rear side of the partition wall 72c.

Furthermore, a notch 71e is arranged in the lower part of the end face 71d of the partition wall 71c of the main body 71, and a communication hole 71e of the first partition wall W1 (71c and 72c) partitioning between the housing space Z1 and the first lubricating oil reservoir space Z2 is formed by contacting the notch 71e with the end face 72 d of the partition wall 72c of the cover 72. Moreover, the fluidic communication state for flow of lubricating oil between the housing space Z1 and the first lubricating oil reservoir space Z2 is restricted by the communication hole 71e.

The second lubricating oil reservoir space Z3 is formed by partitioning the lower part of the main body 71 of the transfer case 70 and the housing space Z1 with an oil path 91 as the second partition wall W2.

Specifically, as shown in FIG. 4 and FIG. 5, the oil path 91 has a basic surface 92 in which a notch is provided on a doughnut-shaped disc, a cylindrical part 93 extending cylindrically from the inner peripheral side of the basic surface 92 to the vehicle body rear side, and a guide part 94 extending from an upper end part of the basic surface 92 to the vehicle body front side. Moreover, a fan-shaped notch 95 is provided on an upper part of the basic surface 92 and a communication hole 96 is provided on a lower part of the basic surface 92.

The basic surface 92 of the oil path 91 is fixed to a mounting part provided on the inner peripheral part of the main body 71 of the transfer case 70 with a plurality of bolts 92a.

Moreover, as shown in FIG. 2 and FIG. 3, the oil path 91 is arranged such that the basic surface 92 and the cylindrical part 93 of the oil path 91 cover the surface of the vehicle body rear side of the longitudinal surface part 22b of the driven gear 22 and the rear side cylindrical part 22d.

Further, a seal member 92b is arranged on the outer peripheral part of the basic surface 92 of the oil path 91, and the oil path 91 and the inner peripheral surface of the main body 71 of the transfer case 70 are sealed by the seal member 92b. Thus, the basic surface 92 of the oil path 91 functions to partition between the housing space Z1 provided on the vehicle body front side across the basic surface 92 and the second lubricating oil reservoir space Z3 surrounded by the basic surface 72 and the inner peripheral part of the main body 71 of the transfer case 70 of the vehicle body rear side. Moreover, the housing space Z1 and the second lubricating oil reservoir space Z3 are partitioned to be in a fluidic communication state in which the communication hole 96 in the oil path 91 restricts flow therebetween.

As shown in FIG. 4, the notch 95 of the oil path 91 is arranged at the position corresponding to the engaging part X between the drive gear 21 and the driven gear 22.

The housing space Z1 fluidically communicates with the second lubricating oil reservoir space Z3 at the notch 95 of the oil path 91. Therefore, the lubricating oil can be reserved up to the level of the end part 95a of the lower part of the notch 95. Moreover, the second lubricating oil reservoir space Z3 and the housing space Z1 are partitioned to be in a fluidic communication state such that the communication hole 96 of the oil path 91 restricts the flow therebetween.

As shown in FIG. 4, the height of the first partition wall W1 is set to a lower position than the second partition wall W2. Since these spaces Z1, Z2, and Z3 fluidically communicate via the communication holes 71e and 96, the oil level of the lubricating oil reserved in the spaces Z1, Z2, and Z3 when the vehicle stops (at the stopping time of the driven gear 22) is the same as the oil level L.

Then an upper end W11 of the first partition wall W1 is set to the lower position than the oil level L when the vehicle stops and is submerged in the lubricating oil. On the other hand, the end part 95a of the lower side of the notch 95 forming the second partition wall W2 is set to a higher position than the oil level L when the vehicle stops and the end part 95a of the lower side of the notch 95 protrudes above the liquid level of the lubricating oil.

Incidentally, for the lubrication of the transfer device 10 according to the present embodiment, the lubricating oil reserved in the housing space Z1 is lapped up and scattered by the toothed surface of the driven gear 22 and supplied to the drive gear 21 side. Moreover, as shown in FIG. 5, in the present embodiment, a side part 22e, which is a front side in the rotation direction R1 of a toothed surface 22a′ of the helical gear which forms the driven gear 22, is formed so as to be on the vehicle body front side.

The lubricating oil of the tooth surface 22a′ of the driven gear 22 flows along a direction indicated by arrow R2 along the inclination of the toothed surface 22a′ of the driven gear 22 in a static condition, however, since the driven gear 22 is rotating in the direction of arrow R1, the lubricating oil is easily scattered to the vehicle body rear side but is hardly scattered to the vehicle body front side.

In order to eliminate undesirable deviations in the supply of the lubricating oil as described above, for the power transmission mechanism 20, a guide part 94 for guiding the lubricating oil to the vehicle body front side is provided on the oil path 91 to supply the lubricating oil to the vehicle body front side.

As shown in FIG. 4 and FIG. 5, a ceiling 94a, which extends along the outer peripheral surface of the driven gear 22 from the upper end part of the basic surface 92 of the oil path 91 so as to cover a part of thereof, and a vertical wall part 94b, which extends from an end part of the engaging part X side of the ceiling 94a to the tooth 22a side of the driven gear 22, are provided on the guide part 94 of the oil path 91. Moreover, the vertical wall part 94b is formed to be inclined in the same inclination direction of the slanted teeth of the toothed surface of the driven gear 22. According to this, as shown the dashed line in FIG. 5, the lubricating oil lapped up by the driven gear is also guided to the vehicle body front side by the guide part 94 of the oil path 91.

Moreover, as shown in FIG. 3, the communication hole 71e of the first partition wall W1 is arranged in a position along the toothed surface of the driven gear and is formed so that the front side in the rotation direction of the toothed surface of the helical gear that forms the driven gear 22 is on the vehicle body front side. Furthermore, the lubricating oil lapped up by the driven gear 22 is directed toward the vehicle body rear side, which is in a flow direction along the tooth surface of the helical gear.

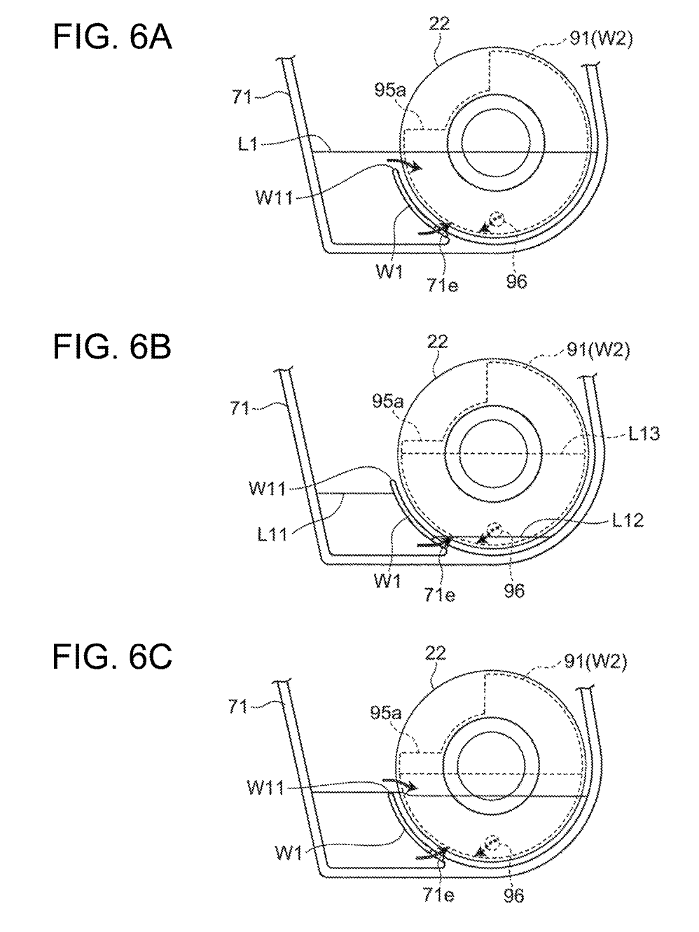

With reference to FIGS. 6A to 6C, the flows of the lubricating oil in the housing space Z1, the first lubricating oil reservoir space Z2, and the second lubricating oil reservoir space Z3 of the transfer device 10 will be described.

In the transfer device 10 configured like this, the driven gear 22, which is enmeshed with the drive gear 21, is rotated at the time of driving, and the lubricating oil reserved in the housing space Z1 is lapped up by the driven gear 22, so that the drive gear 21 side is lubricated.

As described above, when the driven gear 22 stops, the lubricating oil of the housing space Z1, the first lubricating oil reservoir space Z2, and the second lubricating oil reservoir space Z3 becomes the same oil level L via the communication holes 71e and 96 provided in the first and the second partition walls W1 and W2, by flowing under the effect of gravity to an equilibrium state from positions higher than the upper end W11 of the first partition wall W1 (with reference to FIG. 4).

Moreover, at the time of low speed rotation of the driven gear 22, as shown in FIG. 6A, since the amount of the lubricating oil lapped up by the driven gear 22 is small, the oil level of the housing space Z1 drops by only a small amount. Then, since the lubricating oil reserved in the first and the second lubricating oil reservoir spaces Z2 and Z3 flows into the housing space Z1 by the communication holes 71e and 96 provided on the first and second partition walls W1 and W2, the change of the oil level of the lubricating oil reserved in the first and second lubricating oil reservoir spaces Z2 and Z3 is small. Therefore, since the oil level of the first lubricating oil reservoir space Z2 is higher than the first partition wall W1, the lubricating oil is supplied to the housing space Z1 by flowing over the first partition wall W1 in addition to via the communication holes 71e and 96. As a result, the oil level in the housing space Z1 can be maintained at the oil level L1 with no shortage of lubrication at low speed rotation.

On the other hand, at the time of high speed rotation of the second rotation member, as shown in FIG. 6B, since the amount of the lubricating oil lapped up by the driven gear 22 is large, the oil level of the housing space Z1 drops by a large amount. Moreover, since the lubricating oil reserved in the first and second lubricating oil reservoir spaces Z2 and Z3 flows into the housing space Z1 by the communication holes 71e and 96 provided on the first and second partition walls W1 and W2, the oil level of the lubricating oil reserved in the first and second lubricating oil reservoir spaces Z2 and Z3 is increased. Then, when the oil level of the first lubricating oil reservoir space Z2 is lowered down to no more than (i.e., below) the height L11 of the first partition wall W1, since the lubricating oil cannot be reserved any further, the lubricating oil lapped up by the driven gear 22 is collected to the second lubricating oil reservoir space Z3 partitioned by the second partition wall W2 that is set at a higher position than the first partition wall W1.

As a result, since the lubricating oil flowing to the housing space Z1 is supplied only by the communication holes 71e and 96 of the first and the second partition wall W1 and W2, the oil level L12 in the housing space Z1 can be reduced and the stirring resistance during high speed rotation of the driven gear 22 can be reduced.

Moreover, when shifting from high speed rotation to low speed rotation of the second rotation member, as shown in FIG. 6C, since the amount of the lubricating oil lapped up by the driven gear 22 becomes small, the oil level of the housing space Z1 is increased by supplying the lubricating oil from the communication holes 71e and 96. Then, when the oil levels of the housing space Z1 and the first lubricating oil reservoir space Z2 reach the upper end W11 of the first partition wall W1, the lubricating oil that is reserved in the first lubricating oil reservoir space Z2 flows into the housing space Z1 by flowing over the first partition wall W1. According to this, since the lubricating oil is supplied from three directions, namely, the two communication holes 71e and 96 and from a path over the first partition wall W1, the oil level in the housing space Z1 can be maintained at a level sufficient to keep the amount of the lubricating oil that is required at the time of low speed rotation.

With such a configuration, an oil level suitable for both times of low speed rotation and of high speed rotation can be obtained, and improvements can be achieved that address lubrication shortages at times of low speed rotation and reductions of the stirring resistance at times of high speed rotation.

Moreover, in the present embodiment, since the first lubricating oil reservoir space Z2 is provided at a position overlapped with the housing space Z1 as viewed along a direction orthogonal to an axial direction of the drive gear 21 and also the second lubricating oil reservoir space Z3 is provided at a position overlapped with the housing space Z1 as viewed along an axial direction of the drive gear 21, the first lubricating oil reservoir space Z2 and the second lubricating oil reservoir space Z3 are distributed in a manner that effectively utilizes space.

Moreover, a communicating state that restricts the flow of lubricating oil among the housing space, the first lubricating oil reservoir space, and the second lubricating oil reservoir space can be realized with a simple configuration in which the communication holes 71e and 96 are provided on the first partition wall W1 and the second partition wall W2.

The driven gear 22 is formed by the helical gear and since the communication hole of the first lubricating oil reservoir space is provided on the front side in the rotation direction of the tooth surface of the driven gear 22, the lubricating oil that is supplied from the first lubricating oil reservoir space via the communication hole is easily taken into the housing space by the pumping action of the second gear. As a result, the communication hole can be set to be small in size, so that deterioration of the rigidity of the partition wall can be suppressed while providing the communication hole.

Moreover, the power transmission mechanism in the present invention is not limited to the one using gears; rather, a wrapping power transmission mechanism may also be used such as a chain or belt drive. In such a case, a sprocket or a pulley as a power transmission member is included instead of the drive gear and the driven gear.

The present invention is not limited to the exemplified embodiment, without limiting the scope of the present invention, various improvements and design modifications are possible. Thus, it should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### INDUSTRIAL APPLICABILITY

As discussed above, according to the present invention, since the transfer device mounted on a four-wheel drive vehicle can appropriately control the amount of the lubricating oil of the transfer device according to the traveling conditions of the vehicle, it is possible to be used appropriately in the industrial field of manufacturing such kinds of vehicles.

### EXPLANATION OF REFERENCE CHARACTERS

10 Transfer device

11 Output shaft for rear wheels

12 Output shaft for front wheels

20 Power transmission mechanism

21 Drive gear (first rotation member)

22 Driven gear (second rotation member)

70 Transfer case (case)

71e, 96 Communication hole

L Oil level when a vehicle stops (Predetermined oil level)

W1 First partition wall

W2 Second partition wall

Z1 Housing space

Z2 First lubricating oil reservoir space

Z3 Second lubricating oil reservoir space

We claim:

1. A transfer structure for a vehicle, comprising:
a first rotation member arranged at a high position corresponding to a higher one of a drive side power transmission member and a driven side power transmission member;
a power transmission mechanism having a second rotation member arranged at a lower position than the first rotation member;
a case for supporting the first rotation member and the second rotation member;
a housing space for storing the power transmission mechanism in the case,
wherein a lubricating oil is reserved in a lower part of the housing space so as to submerge a lower part of the second rotation member,
wherein the lubricating oil is lapped up by the second rotation member and supplied to the first rotation member,
wherein a first lubricating oil reservoir space and a second lubricating oil reservoir space for reserving the lubricating oil respectively adjacent to the housing space are provided in the case,
wherein a first partition wall partitions between the housing space and the first lubricating oil reservoir space,
wherein a second partition wall partitions between the housing space and the second lubricating oil reservoir space,
wherein a first communication oil passage for communicating in a state of restricting the flow of the lubricating oil between the housing space and the first lubricating oil reservoir space is provided on the first partition wall,
wherein a second communication oil passage for communicating in a state of restricting the flow of the lubricating oil between the housing space and the second lubricating oil reservoir space is provided on the second partition wall, and,
wherein the first partition wall is provided at a lower position than a predetermined oil level set as an oil level when the vehicle stops, and the second partition wall is provided at a higher position than the predetermined oil level.

2. The transfer structure for a vehicle according to claim 1,
wherein the first lubricating oil reservoir space is provided at a position overlapped with the housing space as viewed along a direction orthogonal to an axial direction of the first rotation member.

3. The transfer structure for a vehicle according to claim 1,
wherein the second lubricating oil reservoir space is provided at a position overlapped with the housing space as viewed along an axial direction of the first rotation member.

4. The transfer structure for a vehicle according to claim 1,
wherein the first and second communication oil passages of the first partition wall and the second partition wall are configured by respective communication holes.

5. The transfer structure for a vehicle according to claim 1,
wherein the first rotation member and the second rotation member are helical gears,
wherein a first lubricating oil reservoir space is provided on the front side in a rotating direction of the second rotation member,
wherein the first partition wall is provided along a tooth surface of the second rotation member, and
wherein the first communication oil passage of the first lubricating oil reservoir space is provided on the front side in the rotating direction of the tooth surface of the second rotation member on the first partition wall.
